(19) United States
(12) Patent Application Publication
(10) Pub. No.: US 2011/0183143 A1
(43) Pub. Date: Jul. 28, 2011

(54) PVC COMPOSITION PREPARED FROM RENEWABLE RAW MATERIALS USED FOR DECORATING AN AUTOMOBILE INTERIOR

(75) Inventors: Helene Tarrit, Epernay (FR); Guillaume De Crevoisier, Shanghai (CN); Philippe Bausseron, Le Chatelet s/Retourne (FR); Laurent Liebgott, Reims (FR); Anne Chabrol, Lyon (FR)

(73) Assignee: Arkema France, Colombes (FR)

(21) Appl. No.: 12/994,283

(22) PCT Filed: May 27, 2009
(86) PCT No.: PCT/FR09/50986

§ 371 Date: Feb. 4, 2011

(30) Foreign Application Priority Data
May 29, 2008 (FR) 08.53546

(51) Int. Cl. B32B 27/08; C08L 27/06; C08K 5/12; C08K 5/11; C08K 5/098; B29C 69/02; B32B 27/30

(52) U.S. Cl. 428/413; 524/569; 524/295; 524/310; 524/399; 264/241; 428/522; 428/520; 428/424.6

(57) ABSTRACT

“The present invention relates to a novel PVC resin composition, produced such that the numerical ration of the renewable carbon in the composition relative to the total carbon in the composition is greater than or equal to 30%. Said composition can be used in the manufacture of automobile interior parts and thus meets all the necessary requirements for this use.”

### FIELD OF THE INVENTION

The present invention relates to a novel composition based on PVC resin, such that the ratio of the renewable carbon of the composition with respect to the total carbon of the composition is greater than or equal to 30%. This composition is intended to be used for manufacturing interior motor vehicle parts and therefore meets all the requirements necessary for this application.

### PRIOR ART

PVC resins possess good physical properties, such as mechanical properties, chemical resistance and weather resistance and their cost remains relatively reasonable. This is why semi-rigid or flexible compositions based on PVC resin are most often used for making the outer layer of certain parts of the passenger compartment of vehicles, for example the dashboards or the door panels. This outer layer is then referred to as a “skin”.

Currently, the tendency to reduce costs leads manufacturers to reduce the thickness of this resin layer while increasing their requirements in terms of performance across all fields: resistance to heat ageing, UV resistance, etc. Another tendency which consists in masking the airbag cover (integrated airbag) so that it is not visible to the passengers of the vehicle, means that the requirements in terms of mechanical properties are exceptional, in order to allow the opening in a very short period of time without spraying particles and for temperatures conventionally between −35° C. and +80° C. Furthermore, this layer usually covers another layer made of polyurethane foam which gives a soft appearance to the structure. The presence of this PU foam seriously reduces the ageing resistance of the PVC material. The layer based on PVC resin used in the motor vehicle interior is therefore a high-performance material.

These performances are obtained by virtue of the addition of many varied additives, the most sizeable, by weight, being the plasticizer which provides inter alia flexibility and low temperature resistance. PVC-based compositions intended to be used for the motor vehicle interior are conventionally prepared with plasticizers that contain very little carbon of renewable origin since they are prepared from an alcohol of petroleum origin. These alcohols are obtained by steam cracking or catalytic cracking of petroleum fractions.

The use of these materials contributes to the increase of the greenhouse effect during their end-of-life degradation or incineration. Moreover, given the decline in world petroleum resources, the source of these raw materials is going to gradually run out.

Conversely, the raw materials derived from biomass have a reduced environmental impact. Plant materials also have the advantage of being able to be cultivated in a large amount, depending on demand, throughout most of the world and of being renewable.

It therefore appears necessary to have methods of synthesis and novel compositions that are not dependent on raw material of fossil origin, but that instead use raw materials of renewable origin.

Today, consumers are increasingly attracted by products of plant origin which have the reputation of being safer and cleaner for the environment.

There is therefore a need for novel compositions intended to be used in a motor vehicle passenger compartment, which contain the highest possible content of materials of renewable origin, so that at least 30% of the carbon constituting the composition is of renewable origin.

### DESCRIPTION OF THE INVENTION

The inventors have therefore developed a novel composition comprising, by weight relative to the total weight of the composition, the following compounds:

40% to 60% of one or more PVC resins with a K-value between 50 and 80;

30% to 50% of one or more plasticizers; and

5% to 20% of one or more additives, at least one of said compounds being of renewable origin, so that at least 30% of the carbon of the composition is carbon of renewable origin.

The expression “30% of the carbon of the composition is carbon of renewable origin” is understood, within the meaning of the present invention, to mean 30% by number.

The inventors have shown that such a composition is not only of renewable origin, but meets all the specifications necessary for use in the motor vehicle market.

The expression “compound of renewable origin” is understood, within the meaning of the invention, to mean a plasticizer, an additive and/or a PVC resin which comprises carbon of renewable origin, and which is obtained from a plant or animal raw material.

Indeed, unlike materials derived from fossil materials, materials composed of renewable raw materials contain ¹⁴C. All carbon samples taken from living organisms (animals or plants) are in fact a mixture of 3 isotopes: ¹²C (representing˜98.892%), ¹³C (˜1.108%) and ¹⁴C (traces: 1.2×10¹²%). The ¹⁴C/¹²C ratio of living tissues is identical to that of the atmosphere. In the environment, ¹⁴C exists in two predominant forms: in inorganic form, i.e. in the form of carbon dioxide (CO₂), and in organic form, i.e. in the form of carbon integrated into organic molecules.

In a living organism, the ¹⁴C/¹²C ratio is kept constant by the metabolism since carbon is continually exchanged with the environment. Since the proportion of ¹⁴C is substantially constant in the atmosphere, the same is true in the organism, while it is alive, since it absorbs this ¹⁴C like it absorbs the ¹²C. The average ¹⁴C/¹²C ratio is equal to 1.2×10⁻¹².

¹²C is stable, i.e. the number of ¹²C atoms in a given sample is constant over time. ¹⁴C is itself radioactive (each gram of carbon of a living being contains sufficient ¹⁴C isotope to give 13.6 disintegrations per minute) and the number of such atoms in a sample decreases over time (t) according to the law:

n=no exp(−at)

in which:

no is the number of ¹⁴C at the origin (at the death of the creature, animal or plant),

n is the number of ¹⁴C atoms remaining after time t,

a is the disintegration constant (or radioactive constant); it is linked to the half-life.

The half-life (or half-period) is the period of time after which any number of radioactive nuclei or of unstable particles of a given species is reduced by half by disintegration; the half-life T_{1/2} is linked to the disintegration constant a by the formula a T_{1/2}=In 2. The half-life of ¹⁴C is 5730 years.

Given the half-life (T_{1/2}) of ¹⁴C, it is considered that the ¹⁴C content is substantially constant from the extraction of the plant raw materials to the manufacture of the compound, and even to the end of its use.

The applicant considers that a compound is derived from renewable raw materials if it contains at least 30% by mass of C of renewable origin out of the total mass of carbon, preferably at least 40%, 50%, 60%, 70%, 80%, 85%, 90%, 95% or 98% by mass of C of renewable origin out of the total mass of carbon.

In other words, a compound is derived from renewable raw materials if it contains at least 0.3×10⁻¹⁰% by mass of ¹⁴C, and up to 0.98×10⁻¹% by mass of ¹⁴C.

At the current time, at least two different techniques exist for measuring the ¹⁴C content of a sample:

By liquid scintillation spectrometry: this method consists in counting “beta” particles derived from the disintegration of ¹⁴C. The beta-radiation derived from a sample of known mass (known number of ¹²C atoms) is measured for a certain period of time. This “radioactivity” is proportional to the number of ¹⁴C atoms, which can thus be determined. The ¹⁴C present in the sample emits β-radiation, which, in contact with a liquid scintillant (scintillator), produces photons. These photons have different energies (between 0 and 156 keV) and form what is called a ¹⁴C spectrum. According to two variants of this method, the analysis relates either to the CO₂ produced beforehand by the carbon-based sample in an appropriate absorbent solution, or to the benzene after prior conversion of the carbon-based sample to benzene.

By mass spectrometry: the sample is reduced to graphite or to CO₂ gas, and analysed in a mass spectrometer. This technique uses an accelerator and a mass spectrometer to separate the ¹⁴C ions from the ¹²C ions and therefore to determine the ratio of the two isotopes.

All these methods for measuring the ¹⁴C content of materials are described precisely in the ASTM D 6866 standards (notably D6866-06) and in the ASTM D 7026 standards (notably 7026-04).

The method of measurement preferably used in the case of the compounds of the invention is the mass spectrometry described in the ASTM D6866-06 standard (“accelerator mass spectroscopy”).

Consequently, the composition according to the invention may itself be described as a composition of renewable origin in that it comprises at least 30% by mass of ¹⁴C relative to the total mass of carbons of the composition.

The composition according to the invention comprises 40% to 60% of one or more PVC resins with a K-value between 50 and 80. A PVC resin having a K-value between 50 and 80 may be obtained by a process in suspension; but PVC manufactured in emulsion or in bulk may also be used.

Preferably, the PVC resin used in the composition according to the invention is also of renewable origin.

A process for obtaining PVC of renewable origin is described below.

A process for obtaining PVC of renewable origin which may be used in a composition according to the invention is described below.

It comprises, in a first step, the fermentation of biomass in order to obtain ethanol, a step of dehydration of ethanol to ethylene, the conversion of ethylene to vinyl chloride monomer (VCM), then the synthesis, in emulsion, of PVC from VCM. These steps are described in detail below.

The first step of the process for obtaining PVC of renewable origin comprises the fermentation of at least one plant material in order to produce ethanol. This plant material may especially be chosen from sugars, starch and the plant extracts containing them, among which mention may be made of beet, sugar cane, cereal plants such as wheat, barley, sorghum or corn, and also potato, without this list being limiting. It may alternatively be biomass (mixture of cellulose, hemicellulose and lignin). Ethanol is then obtained by fermentation, for example using Saccharomyces cerevisiae. The plant material used is generally in hydrolyzed form before the fermentation step. This preliminary hydrolysis step thus enables, for example, the saccharification of the starch in order to convert it to glucose, or the conversion of sucrose to glucose.

These fermentation methods are well known to a person skilled in the art. They comprise, for example, the fermentation of plant materials in the presence of one or more yeasts, followed by a distillation that makes it possible to recover the ethanol in the form of a more concentrated aqueous solution which is then treated with a view to further increasing its molar concentration of ethanol.

In the second step of the process according to the invention, the ethanol obtained by fermentation is dehydrated in a first reactor to a mixture of ethylene and water. It is preferred that the alcohol is injected at the top of the first reactor. This dehydration step is generally carried out in the presence of a catalyst, which may, in particular, be based on γ-alumina. An example of a catalyst suitable for the dehydration of ethanol is sold, in particular, by EUROSUPPORT under the trade name ESM 110®. This is an undoped trilobe alumina containing little residual Na₂O (usually 0.04%). A person skilled in the art will be able to choose the optimal operating conditions for this dehydration step. By way of example, it has been demonstrated that a ratio of the volume flow rate of liquid ethanol to the volume of catalyst of 1 h⁻¹ and an average temperature of the catalyst bed of 400° C. resulted in an almost complete conversion of the ethanol with an ethylene selectivity of the order of 98%.

The ethylene obtained in this step of the process is converted to dichloroethane by direct chlorination or by oxychlorination with oxygen and hydrochloric acid. The dichloroethane is then subjected to a cracking step at around 500° C. in order to form the vinyl chloride monomer.

The direct chlorination step may be represented by the following reaction:

C₂H₄+Cl₂→C₂H₄Cl₂

The oxychlorination step may be represented by the following reaction:

C₂H₄+ 1/2O₂ +2HCl→C₂H₄Cl₂+HCl

The cracking step may be represented by the following reaction:

(CH₂Cl)₂→CH₂CHCl+HCl

When all the hydrochloric acid produced in the oxychlorination step is reused in the oxychlorination step, and when no amount of dichloroethane or of hydrochloric acid is imported from the outside or exported, then the VCM production unit is said to be “balanced”.

During the direct chlorination step, dichloroethane is synthesized by an exothermic reaction between ethylene and chlorine. The dichloroethane produced is generally used as a reaction medium. The reaction temperature is generally between 50 and 120° C. and the pressure may vary from atmospheric pressure to 5 bar. The reaction is generally catalyzed by metal chlorides, in particular ferric chloride, but aluminum, copper and antimony chlorides may also be used.

The dichloroethane yield of the direct chlorination reaction is generally greater than 99%. The reaction also produces less than 1% of other chlorinated hydrocarbons, in particular of 1,1,2-trichloroethane and of ethyl chloride, An inhibitor based on oxygen, or optionally on dimethylformamide, may be used to reduce the formation of chlorinated by-products, in particular of 1,1,2-trichloroethane by substitution reactions.

The direct chlorination step may be carried out either at low temperature or at high temperature.

Low-temperature direct chlorination is carried out at a temperature below the boiling point of dichloroethane, namely generally at a temperature below 70° C. The liquid dichloroethane leaving the reactor must generally be washed in order to remove the catalyst, thus resulting in a wet dichloroethane which requires drying and distillation before the cracking step.

Low-temperature direct chlorination produces slightly less by-products than high-temperature direct chlorination, but requires more energy due to the need to distill the dichloroethane. The concentration of 1,1,2-trichloroethane at the end of the reaction is generally between 300 and 800 ppm by weight.

High-temperature direct chlorination is carried out at a temperature above the boiling point of dichloroethane, namely generally at a temperature above 90° C. The dichloroethane leaves the reactor in vapor form. It is thus possible to convey it directly to the cracking step, without prior washing or distillation. Furthermore, since the energy released by the formation of dichloroethane is equal to six times the vaporization energy, it is possible to recover energy, for example in order to purify the dichloroethane resulting from the low-temperature direct chlorination, oxychlorination, or optionally the dichloroethane that is not converted during the cracking and that is recycled.

During high-temperature direct chlorination, since the dichloroethane is produced in vapor form, there is an accumulation of catalyst in the reactor. The concentration of 1,1,2-trichloroethane at the end of the reaction is generally between 1000 and 3000 ppm by weight.

The oxychlorination step is the step via which ethylene, oxygen and hydrochloric acid react together to form dichloroethane and water. The reaction generally takes place in the presence of a catalyst which mainly contains cupric chloride, at a temperature of between 220° C. and 250° C. and at a pressure varying from 2 to 6 barg. The reaction may be carried out in a fixed bed or in a fluidized bed. Fluidized-bed reactors have a better temperature uniformity and make it possible to work at lower temperatures and pressures. The reaction is highly exothermic and it is important to control the temperature in order to minimize the formation of undesirable by-products. The heat of the reaction may be recovered by cooling on a cold surface in order to generate steam.

Besides the cupric chloride, the catalyst may contain other components, such as potassium chloride. The presence of potassium chloride reduces the overall activity of the catalyst, but has a predominant influence on the reduction of the reaction rate of direct oxidation reactions. The use of potassium therefore makes it possible to improve the selectivity of the reaction for conversion of ethylene to dichloroethane.

The hydrochloric acid used in the reaction may be recycled from the cracking of the dichloroethane and from the purification of the VCM, but it is also possible to use an external source of dry gaseous hydrochloric acid of suitable purity.

The source of oxygen may be ambient air, oxygen or a mixture of the two. The air systems require the air and ethylene to be introduced slightly in excess relative to the stoichiometric amounts in order to ensure a high conversion of the hydrochloric acid, but this increases the formation of chlorinated by-products and produces a larger amount of exhaust gases. Oxygen systems require a larger excess of ethylene, and make it possible to work at a lower temperature, resulting in a yield which significantly reduces the by-products and the exhaust gases. However, the production of oxygen from air is more expensive in terms of energy.

The products of the oxychlorination reaction are separated from the inert gas stream by cooling and condensing at decreasing temperature levels. It may be useful to carry out an additional separation of the residual dichloroethane from the inert gas mix by adsorption or absorption.

After cooling and condensing, the water and the dichloroethane, with other chlorinated organic hydrocarbons, naturally separate into two phases since the dichloroethane and most of the other chlorinated organic hydrocarbons have a low solubility in water.

After the direct chlorination step and/or the oxychlorination step, the dichloroethane undergoes a cracking step in order to form vinyl chloride monomer.

The dichloroethane used in the cracking step may also originate from the VCM purification step, or else from an external source.

Whatever the source, the dichloroethane must be purified since the pyrolysis step carried out during the cracking may be prone to inhibition or fouling due to traces of impurities.

The purification of dichloroethane may consist of the following operations:

washing with water and with caustic products in order to remove the traces of hydrochloric acid, of catalyst and of certain water-soluble organic compounds, such as chloral and 2-chloroethanol. This operation is often integrated into the direct chlorination step, especially when low-temperature direct chlorination is used;

distillation of the light fractions in one or two columns in order to remove the water and the chlorinated by-products that have a boiling point below that of dichloroethane, such as chloroform, ethyl chloride and carbon tetrachloride; some of the dichloroethane is lost with the light fractions due to the presence of azeotropes;

distillation of the heavy fractions in order to remove the chlorinated by-products whose boiling point is greater than that of dichloroethane, especially 1,1,2-trichloroethane and C₄ compounds; pure dry dichloroethane is recovered at the top of the column;

other operations for purification of the heavy or light fractions, for example by distillation or by chemical reactions, to recover more dichloroethane, to remove water from the light fractions, or to separate the fractions used as feed stock for other chlorination processes; and

chlorination reaction in order to convert the light products, which it would be difficult to separate from dichloroethane using distillation, into heavy products.

After the dichloroethane purification step, the production of vinyl chloride monomer from dichloroethane is obtained by a cracking reaction followed by a step of cooling the gases produced. The cracking is carried out in a furnace heated at a temperature generally between 400 and 500° C., the pressure generally being between 25 and 30 bar. The residence time in the furnace is typically between 5 and 20 seconds.

The purity of the dichloroethane fed to the furnace is preferably greater than 99.5% in order to reduce the formation of coke and the fouling of the furnace. The dichloroethane must also be dry in order to prevent the corrosion of the installations by hydrogen chloride.

The furnace is generally gas-fired.

The dichloroethane is converted to VCM at degrees of conversion between 50 and 65%. The selectivity with respect to VCM is generally from 98 to 99%.

A rapid cooling of the pyrolysis product is important for reducing the formation of tar and of heavy by-products. Cold dichloroethane generally acts as cooling media.

After cooling, the pyrolysis product is generally sent to a fractionation device in order to separate and recover the hydrochloric acid, the unconverted dichloroethane, the vinyl chloride and the light or heavy by-products, such as 1,1,1-trichloroethane, chloroform and carbon tetrachloride. The dichloroethane may be sent back to the cracking unit for a further conversion to VCM, and the hydrochloric acid may be sent to the oxychlorination reactor if an oxychlorination step is used.

In an additional step, the VCM is converted to PVC having a K-value between 50 and 80 via a process in suspension; but PVC manufactured in emulsion or in bulk may also be used.

In one preferred embodiment, the weight ratio of the plasticizer of renewable origin relative to the plasticizer of petroleum origin is greater than or equal to 1.5.

In one alternative embodiment, all of the plasticizers of the composition are of renewable origin.

Among the plasticizers which may be used according to the invention, mention may be made of the standard plasticizers as chosen from the group of azelates, trimellitates, sebacates, adipates, phthalates, citrates, benzoates, tallates, glutarates, fumarates, maleates, oleates, palmitates and acetates, these plasticizers possibly being of petroleum origin or of renewable origin.

By way of example of plasticizers of renewable origin, mention may be made of the compounds obtained by esterification of a carboxylic acid, preferably of renewable origin, and alcohols compulsorily originating from biomass. Mention may be made, for example, of a trioctyl trimellitate, also known as tri(n-octyl) trimellitate and in particular the product sold by Polynt under the trade name Diplast TM8®, bearing the CAS number: 89-04-3, resulting from the esterification of trimellitic acid and of octanol originating from palm oil.

This plasticizer is preferred since it gives the compound excellent low-temperature properties and thus makes it possible to satisfy the requirements of integrated airbags.

The trioctyl trimellitate of renewable origin, that is to say resulting from the esterification of trimellitic acid and of octanol originating from palm oil, has very good compatibility with the PVC resin, that is to say that no exudation of the plasticizer is observed after mixing with the PVC resin, and very good absorption is observed on the PVC resin at low temperature.

As plasticizers of renewable origin, mention may also be made of green plasticizers of isosorbide type.

Other esters of plant origin derived from glycerol may be used, for example a fully acetylated monoglyceride of fully hydrogenated castor oil, in particular the product sold by Danisco under the trade name Soft'n'Safe®, bearing the CAS number: 736150-63-3.

The composition that is the subject of the invention may comprise a mixture of plasticizers, some of petroleum origin and others partially or completely of renewable origin.

The composition according to the invention comprises 5 to 20% of additives. Among the additives commonly used in compositions based on vinyl resin, mention may be made of organic carboxylic acid metal salts, organic phosphoric acids, zeolites, hydrotalcites, epoxide compounds, β-diketones, polyhydric alcohols, phosphorous-containing, sulfur-containing or phenolic antioxidants, ultraviolet absorbers, for example benzophenones, benzotriazoles and oxanilide derivatives, cyanoacrylates, hindered amine light stabilizers (HALSs), perchloric acid salts, and other metal-based inorganic compounds, lubricants, for example organic waxes, fatty alcohols, fatty acids, esters, metal salts, fillers, for example chalk and talc, blowing agents, for example azodicarbonamides, and pigments such as carbon black, and copper phthalocyanines.

By way of example of additives of renewable origin, mention may be made of the compounds used for their lubricating properties such as epoxidized soybean oils, organic waxes, such as polyethylene wax, fatty alcohols, fatty acids, such as stearic acid, and esters. Mention may also be made of pigments of plant or animal origin, reinforcing fibers of natural origin such as hemp, processing aids such as those comprising 80% by weight of butyl acrylate and 20% by weight of methyl methacrylate, impact modifiers of acrylic type comprising 85 to 90% by weight of butyl acrylic, 5 to 10% by weight of methyl methacrylate and 5 to 10% by weight of butadiene, stabilizers based on renewable carbon of polyol type, such as glycerol, sorbitol and erythritol.

Thus, when one or more compounds of the invention are of renewable origin, the composition may comprise up to 80%, preferably up to 90%, and very preferably up to 98% of carbon of renewable origin.

Preferably, the composition according to the invention is in the form of a dry powder, the plasticizer being thoroughly absorbed into said powder. One or more additives may be added in order to improve the flowability of the powder according to the invention, so as to obtain a non-caking product of fine particle size with excellent flowability. Preferably, 1-10% and preferably between 3 and 8%, by weight relative to the total weight of the composition, of a flowability agent is added, which flowability agent is a PVC resin preferably obtained by a conventional technique of emulsion polymerization or by a conventional technique of microsuspension polymerization. Resins obtained by a microsuspension polymerization process are especially described in application FR 2309569.

Preferably, the composition according to the invention is in the form of a powder, for which the particles that constitute it have an average size between 50 and 500 μm, preferably between 100 and 200 μm.

Thus, this composition is especially suitable for processing by rotomolding.

In order to improve the absorption of the plasticizer into the PVC resin, use will preferably be made of a heated powder blender, in the following manner;

the PVC resin is heated in a powder blender in order to increase its absorption capacity;

the plasticizer is heated separately in order to fluidize it;

the plasticizer is introduced slowly into the blender for a duration sufficient for its diffusion into the resin; and

the mixture obtained is cooled in another jacketed powder blender.

The invention also relates to the use of the composition according to the invention for obtaining a layer of composite skin or structure, for the passenger compartment parts of motor vehicles, especially dashboards equipped with airbags, the outer surface of said layer being covered with a coating chosen from compositions based on epoxy resin, polyurethane resin, PVC or acrylic resins.

Another subject of the invention is a process for obtaining a layer of composite skin or structure, for the passenger compartment parts of a motor vehicle, especially dashboards equipped with airbags, comprising the deposition of a composition according to the invention in a mold, followed by a second step of heating said composition in order to obtain a layer of composite skin or structure.

The invention also relates to a layer of composite skin or structure comprising a composition as defined above.

The invention is also illustrated by the following examples. It is understood that the invention is not limited to these examples.

### Example 1

Typical formulations, known as compounds, were prepared by dry blending in accordance with the formulations described below. The dry-blending process consists in mixing a PVC resin powder with various powder or liquid additives (plasticizers, stabilizers, pigments, etc.) using methods that are well known in the industry. Typically, the PVC resin is mixed with liquid and solid additives in a jacketed reactor during a heating and mixing cycle which reaches a maximum temperature of around 140° C. The mixture is then cooled in the same reactor or in a separate reactor.

Formulation (weight percentages)

| | |
|---|---|
| Suspension PVC resin | 46 |
| Emulsion PVC resin | 5 |
| Epoxidized soybean oil | 2.6 |
| Calcium/zinc stabilizer | 1.3 |
| Sodium perchlorate | 0.3 |
| Zinc stearate | 0.1 |
| UV absorber (benzotriazole type) | 0.1 |
| Sodium zeolite (A) | 1.0 |
| Plasticizers (listed in Table 1) | 44 |

As a function of the type of plasticizer or plasticizer mixture used, compositions A0, A1, A2, A3 and A4 are obtained.

TABLE 1

| | (weight percentages) | | | |
|---|---|---|---|---|
| | A0 | A1 | A2 | A3 |
| Trialkyl trimellitate with C7-C9 chains | 44 | | | |
| Trialkyl trimellitate with C8 chains | | 44 | 33 | 22 |
| (renewable origin) | | | | |
| Trialkyl trimellitate with C8-C10 chains | | | 11 | 22 |
| (renewable origin) | | | | |

Compositions A1, A2 and A3 are compositions according to the invention. Composition A0 forms a comparative example.

Skins were then produced from the powders obtained. 300 g of powder is poured into a mold preheated at 230° C. After 20 seconds, the mold is turned over to remove the excess powder. The whole assembly is put back into an oven for 40 seconds in order to ensure good gelling. The whole assembly is then immersed in a water bath at 23° C. A skin having a thickness of around 1 mm is obtained.

The various features of the compounds are evaluated with the following methods:

The flowability of the powder is measured by filling an hourglass, the orifice of which has a diameter of 2 mm. When the orifice is opened, the ability of the powder to flow is determined: “Flows” if the latter flows completely out of the hourglass, “Does not flow” if not.

The IRHD hardness is tested according to the ASTM D1415 standard. A value between 70 and 80 complies with the specifications required for a motor vehicle application.

The fogging is measured according to the DIN 75201a standard. A value greater than 85% complies with the specifications required for a motor vehicle application.

The low-temperature resistance is evaluated through the value of the glass transition temperature (T_{g}). The latter is measured by dynamic mechanical analysis (DMA). The lower this temperature is, the better the low-temperature resistance will be. A T_{g} below −20° C. generally ensures a sufficient resistance for opening of a separate airbag at the lowest temperatures. A T_{g} at least below −35° C. is necessary for integrated airbags.

The thermal ageing resistance is measured by depositing samples comprising a lower layer of polyurethane foam (thickness of 2 cm, Bayer IF02H foam, obtained by reaction between a polyol and an isocyanate) and an upper layer of PVC skin. The initial color of the upper layer is measured by a spectrophotometer according to the CIE Lab measurement scale. The samples used for this test are of gray color. This assembly is placed in an oven thermostatically controlled at 120° C. for 500 h. The color after ageing is then measured and the variation in color makes it possible to evaluate the thermal ageing resistance. The variation Delta E (DE) is calculated by taking the square root of the sum of the squares of the three variations of the three components L, a and b, according to equation 1 below:

(DE=\sqrt{Da2+Db²+DL²}). Equation 1

Typically, a value of below 4 complies with the specifications required for a motor vehicle application.

The percentage of renewable carbon is measured according to the ASTM D6866 standard.

The results presented below show that the formulations obtained according to the invention, based on trimellitates of renewable origin, comply with the specifications required for a motor vehicle application and have a renewable carbon content of greater than 30% unlike the sample based on trimellitate of petroleum origin.

TABLE 2

| | A0 | A1 | A2 | A3 |
|---|---|---|---|---|
| Flowability | Flows | Flows | Flows | Flows |
| IRHD hardness | 74 | 72 | 73 | 74 |
| Fogging (%) | 94 | 95 | 96 | 95 |
| Tg (° C.) | −35 | −36 | −39 | −37 |
| Thermal ageing | 2.0 | 2.0 | 1.8 | 1.6 |
| resistance, DE | | | | |
| % C_{renewable} | 14 | 43 | 36 | 31 |

### Example 2

Compounds were prepared by dry blending, in accordance with the following formulations, in the same way as in Example 1.

Formulation (weight percentages)

| | |
|---|---|
| Suspension PVC resin | 49 |
| Emulsion PVC resin | 5 |
| Epoxidized soybean oil | 2.7 |
| Calcium/zinc stabilizer | 1.3 |
| Sodium perchlorate | 0.3 |
| Zinc stearate | 0.1 |
| UV absorber (benzotriazole type) | 0.1 |
| Sodium zeolite (A) | 1.1 |
| Plasticizers (listed in Table 3) | 40 |

Depending on the type of plasticizer used, compositions B0 and B1 are obtained.

TABLE 3

| | (weight percentages) | |
|---|---|---|
| | B0 | B1 |
| Tri-2-ethylhexyl trimellitate | 40 | |
| Soft'n'Safe (renewable origin) | | 40 |

Composition B1 is a composition according to the invention. Composition BO forms a comparative example.

The results presented below show that the formulation B1 obtained according to the invention based on the plasticizer of renewable origin sold by Danisco under the trade name Soft'n'Safe complies with the specifications required for a separate airbag or door panel motor vehicle application and has a renewable carbon content considerably greater than 30%, unlike the sample B0 based on trimellitate of petroleum origin.

TABLE 4

| | B0 | B1 |
|---|---|---|
| Flowability | Flows | Flows |
| IRHD hardness | 74 | 77 |
| Fogging (%) | 90 | 91 |
| Tg (° C.) | −26 | −27 |
| Thermal ageing | 1.8 | 2.0 |
| resistance, DE | | |
| % C_{renewable} | 5 | 46 |

1. A composition comprising by weight relative to the total weight of the composition, the following compounds:
a) 40% to 60% of one or more polyvinyl chloride (PVC) resins with a K-value between 50 and 80, of renewable origin;
b) 30% to 50% of one or more plasticizers; and
c) 5% to 20% of one or more other additives, one or more of said compounds being of renewable origin, so that at least 30% of the carbon of said composition is carbon of renewable origin.

2. The composition as claimed in claim 1, wherein the weight ratio of the plasticizer of renewable origin relative to the plasticizer of petroleum origin is greater than or equal to 1.5.

3. The composition as claimed in claim 1, wherein all of the plasticizers of the composition are of renewable origin.

4. The composition as claimed in claim 1, wherein said composition it comprises up to 80% of carbon of renewable origin.

5. The composition as claimed in claim 1, wherein said plasticizer it comprises a trioctyl trimellitate.

6. The composition as claimed in claim 1, wherein said plasticizer comprises a fully acetylated monoglyceride of fully hydrogenated castor oil.

7. The composition as claimed in claim 1, wherein said additives are selected from the group consisting of organic carboxylic acid metal salts, organic phosphoric acids, zeolites, hydrotalcites, epoxide compounds, β-diketones, polyhydric alcohols, phosphorus-containing, sulfur-containing or phenolic antioxidants, ultraviolet absorbers, hindered amine light stabilizers, perchloric acid salts, metal-based inorganic compounds, lubricants, fillers, blowing agents, pigments and mixtures thereof.

8. A layer of composite skin or structure comprising the composition of claim 1, for the passenger compartment parts of motor vehicles.

9. A process for obtaining a layer of composite skin or structure, for the passenger compartment parts of a motor vehicle, especially dashboards equipped with airbags, comprising the deposition of a composition as claimed in claim 1 in a mold, followed by a second step of heating said composition in order to obtain a layer of composite skin or structure.

10. The composition of claim 1 comprising a layer of composite skin or structure.

11. The composition as claimed in claim 4, wherein said composition comprises up to 90% of carbon of renewable origin.

12. The composition as claimed in claim 11, wherein said composition comprises up to 98% of carbon of renewable origin.

13. The layer of composite skin or structure of claim 8, wherein said passenger compartment parts of motor vehicles comprise dashboards equipped with airbags.

14. The layer of composite skin or structure of claim 13, the outer surface of said layer is covered with a coating chosen from compositions based on epoxy resin, polyurethane resin, PVC or acrylic resins.
